(19) United States
(12) Patent Application Publication
(10) Pub. No.: US 2011/0167961 A1
(43) Pub. Date: Jul. 14, 2011

(54) METHOD FOR PURIFYING MATERIAL CONTAINING METALLOID ELEMENT OR METAL ELEMENT AS MAIN COMPONENT

(75) Inventors: Kunio Saugusa, Tsukubamirai-shi (JP); Hiroshi Tabuchi, Tsukuba-shi (JP); Tomohiro Megumi, Imabari-shi (JP)

(73) Assignee: SUMITOMO CHEMICAL COMPANY, LIMITED, Tokyo (JP)

(21) Appl. No.: 13/058,464

(22) PCT Filed: Aug. 10, 2009
(86) PCT No.: PCT/JP2009/064145

§ 371 Date: Mar. 17, 2011

(30) Foreign Application Priority Data
Aug. 11, 2008 (JP) 2008-207313
Apr. 28, 2009 (JP) 2009-109414

(51) Int. Cl. B22F 9/16; C01B 33/037; C22B 5/00; C22B 5/12; C22B 15/00; C22B 23/00; C22B 41/00

(52) U.S. Cl. 75/343; 423/348; 75/392; 75/414

(57) ABSTRACT

It is possible to efficiently obtain a purified material from a material containing a metalloid element such as silicon or metal element as the main component, and an impurity. The method for purifying a material, comprising bringing a material containing a metalloid element or metal element as the main component, and an impurity into contact with a compound represented by the following formula (1):

AlX₃ (1)

wherein X is a halogen atom; to remove the impurity from the material.

### TECHNICAL FIELD

The present invention relates to a method for purifying a material containing a metalloid element or metal element as the main component.

### BACKGROUND ART

When silicon in a molten state is brought into contact with silicon tetrachloride gas, the silicon is chlorinated and gasifies. Silicon purifying methods exist wherein the silicon chloride gas is recovered and the recovered gas is cooled to deposit a portion of the gas as high-purity silicon (see Patent document 1).

It has also been attempted to remove an impurity from silicon by bringing silicon tetrachloride gas or hydrochloric acid into contact with molten silicon (see Patent documents 2-4).

### CITATION LIST

### Patent Literature

[Patent document 1] Japanese Unexamined Patent Application Publication SHO No. 60-103016
[Patent document 2] Japanese Unexamined Patent Application Publication SHO No. 63-103811
[Patent document 3] Japanese Unexamined Patent Application Publication SHO No. 64-69507
[Patent document 4] Japanese Unexamined Patent Application Publication SHO No. 64-76907

### SUMMARY OF INVENTION

### Technical Problem

However, the silicon purifying method disclosed in Patent document 1 allows the silicon as starting material to melt, then silicon tetrachloride gas to be blown into the molten silicon, the silicon to be chlorinated and gasified, and the gasified silicon is recovered and cooled, and therefore the purification procedure is highly complex. In addition, since the finally obtained silicon is the gasified silicon portion among the molten silicon, and the portion of the gasified silicon that becomes silicon deposited by cooling, the problem of low yield of purified silicon is faced.

Furthermore, using silicon tetrachloride gas or hydrochloric acid in the silicon purification step has led to gasification of the silicon to be purified, and it has therefore been difficult to efficiently obtain purified silicon. A novel purifying method for metalloid elements or metal elements other than silicon has also been sought.

It is an object of the present invention to efficiently obtain a purified material from a material containing a metalloid element such as silicon or a metal element as the main component, and also containing impurities.

### Solution to Problem

The method for purifying a material according to the invention comprises a step of comprising bringing a material containing a metalloid element or metal element as the main component, and an impurity into contact with a compound represented by the following formula (1):

AlX₃ (1)

wherein X is a halogen atom; to remove the impurity in a material.

According to the method for purifying a material of the invention, a material containing a metalloid element or metal element as the main component, and an impurity, is brought into contact with a compound represented by formula (1) above, and this allows efficient purification of the material.

It is preferable that the material contain silicon, germanium, copper or nickel as the main component, and it is more preferable that the material contain silicon as the main component.

If silicon is the main component, it is preferable that the impurity in the material be one or more elements selected from the group consisting of lithium, sodium, potassium, rubidium, cesium, beryllium, magnesium, calcium, strontium, barium, zirconium, aluminum, titanium, gallium, indium, vanadium, manganese, chromium, tin, lead, germanium, iron, boron, zinc, copper, nickel and rare earth metals, or an alloy comprising one or more of these elements.

If the main component of the material is germanium, it is preferable that the impurity be one or more elements selected from the group consisting of lithium, sodium, potassium, rubidium, cesium, beryllium, magnesium, calcium, strontium, barium, zirconium, aluminum, titanium, gallium, indium, vanadium, manganese, chromium, tin, lead, silicon, iron, boron, cobalt, zinc, copper, nickel and rare earth metals, or an alloy comprising one or more of these elements.

If the main component of the material is copper, it is preferable that the impurity be one or more elements selected from the group consisting of lithium, sodium, potassium, rubidium, cesium, beryllium, magnesium, calcium, strontium, barium, zirconium, aluminum, titanium, gallium, indium, vanadium, manganese, chromium, tin, lead, silicon, germanium, iron, cobalt, boron, zinc, nickel and rare earth metals, or an alloy comprising one or more of these elements.

If the main component of the material is nickel, it is preferable that the impurity be one or more elements selected from the group consisting of lithium, sodium, potassium, rubidium, cesium, beryllium, magnesium, calcium, strontium, barium, zirconium, aluminum, titanium, gallium, indium, vanadium, manganese, chromium, tin, lead, silicon, germanium, iron, cobalt, copper, boron, zinc and rare earth metals, or an alloy comprising one or more of these elements.

It is preferable that the material be also in a molten state.

If the material containing a metalloid element or metal element as the main component, and an impurity is in a molten state, the compound AlX₃ represented by formula (1) above can be introduced into a molten bath of the material, the contact efficiency between the impurity and AlX₃ can be increased, and reaction between the impurity and AlX₃ can be efficiently accomplished. This can efficiently reduce impurities in the material containing a metalloid element or metal element as the main component.

It is preferable that the material be a powder, i.e. solid powder. If the material containing a metalloid element or metal element as the main component and an impurity is a powder, the contact area between the material and the compound AlX₃ represented by formula (1) above can be increased, in other words, the contact efficiency between an impurity and AlX₃ can be increased and reaction between the impurity and AlX₃ can be efficiently accomplished. This can efficiently reduce an impurity in the material containing a metalloid element or metal element as the main component.

It is preferable that the particle size of the powder be from 100 μm to 5 mm, and it is more preferable that it be from 0.5 mm to 1 mm. If the particle size is less than 100 μm, handling will become difficult, and this is therefore undesirable. If the particle size exceeds 5 mm, the specific surface area will decrease, the contact area between the compound AlX₃ represented by formula (1) above and the material will decrease, and the reaction will proceed with difficulty, and this is therefore undesirable.

The material contains silicon at 97% by mass or greater, and it is preferable that the material contain silicon of from 99% by mass to 99.99% by mass. Such a material is usually called as metallurgical grade silicon, and according to the invention, an impurity can be efficiently removed from such a material.

When the main component of the material is silicon, for example, it is preferable that the temperature of the material be 600° C. or higher and less than 2000° C., and more preferable that it be 1420° C. or higher and less than 2000° C. If it is below 600° C., removal of the impurity from the silicon will be difficult, and this is therefore undesirable. The melting point of silicon is approximately 1410° C., and if the temperature of the material is at least 1420° C., the material will be in a molten state. If the temperature is above 2000° C., loss will occur in the silicon to be purified due to gasification of silicon, and this is therefore undesirable.

It is preferable that the compound AlX₃ represented by formula (1) above be a gas. If AlX₃ is a gas, it will be possible to accomplish suitable reaction with the impurity in the material containing a metalloid element or metal element as the main component.

It is preferable that the gaseous compound AlX₃ represented by formula (1) be present in a gaseous mixture with an inert gas. If AlX₃ is present alone, more unreacted AlX₃ will remain during reaction between the AlX₃ and the impurity in the material containing a metalloid element or metal element as the main component, and will be discharged out of the system without being used in the reaction, and this is therefore undesirable. The presence of AlX₃ in a gaseous mixture with an inert gas allows the AlX₃ to be suitably diluted to control the amount of unreacted AlX₃. That is, the amount of AlX₃ supplied during the reaction can be reduced, and cost reduction for the reaction process can be achieved. It is preferable that the inert gas be one selected from the group consisting of argon, nitrogen and helium, or a mixed gas comprising two or more thereof.

It is preferable that the compound AlX₃ represented by formula (1) above be AlCl₃. When AlCl₃ reacts with an impurity M′ in the material, it is reduced to the subhalides AlCl₂ and AlCl. When M′ is an element that adopts divalent and monovalent forms, M′Cl₂, M′Cl and the like, which are produced chlorides of the impurity M′, are stable chemical species and their physical properties, such as melting point and boiling point, will differ significantly from those of the main component M, so that they can therefore be easily separated and removed from the metalloid element M or metal element M as the main component. This allows purification of the material containing the metalloid element M or metal element M as the main component. Since AlCl₃ hardly allow the metalloid element M or metal element M to be purified to be chlorinated and gasified, the purified metalloid element M or metal element M can be efficiently obtained.

It is preferable that the compound represented by formula (1) above be AlCl₃, and the concentration of the AlCl₃ in the gaseous mixture be 10% by volume or greater and not greater than 40% by volume. If the concentration is less than 10% by volume, almost no reaction will proceed between the impurity and AlCl₃ in the material, and this is therefore undesirable. If the concentration exceeds 40% by volume, a portion of the AlCl₃ will tend to be discharged out of the reaction system without participating in the reaction and the reaction will not take place efficiently, and this is therefore undesirable.

### Advantageous Effects of Invention

According to the invention it is possible to efficiently obtain a purified material from a material containing a metalloid element such as silicon or metal element as the main component and an impurity.

### BRIEF DESCRIPTION OF DRAWINGS

FIG. 1 shows a relationship between a temperature and Gibbs' free energy of Reaction for each element.

FIG. 2 is a partial magnified view of FIG. 1.

FIG. 3 shows an example of a purification apparatus for carrying out a method for purifying a material.

FIG. 4 shows an example of applying the purification apparatus of FIG. 3.

### DESCRIPTION OF EMBODIMENTS

Preferred embodiments according to the present invention will be described below with reference to the attached drawings. In the description for the drawings, the same reference numerals will be put on the same or corresponding element, and overlapping descriptions will be omitted. In addition, a dimensional ratio in each drawing does not necessarily match an actual dimensional ratio.

The present invention provides a method for purifying a material comprising bringing a material containing a metalloid element or metal element as the main component and an impurity into contact with a compound represented by the following formula (1).

AlX₃ (1)

Here, X is a halogen atom.

First, the material to be purified and the compound used for purification of the material will be explained.

The main component of the material to be purified is a metalloid element or metal element. A metalloid element, or metalloid, is an element that is classified as a non-metal element but exhibits the tendencies of a metal element.

Metalloid elements include silicon, germanium, boron, arsenic, antimony and selenium. Metal elements include copper, nickel, tantalum and tungsten.

The main component is not particularly restricted so long as it is a metalloid element or metal element, but it is preferable that it be silicon, germanium, copper or nickel, and especially silicon, which has high practical utility as a material used in solar cells and the like. In the present invention, the main component of the material to be purified means a component of at least 90% by mass based on the total mass of the material.

The compound used for purification of the material is a compound represented by the general formula AlX₃. X is a halogen atom. The halogen atoms include fluorine, chlorine, bromine and iodine. It is preferable that AlX₃ be AlF₃ or AlCl₃, which have low toxicity, and from the viewpoint of ready availability and stability of the produced halide, it is most preferable that it be AlCl₃ wherein X is Cl. Also, AlCl₃ must be an anhydride.

It is preferable that the purity of the AlX₃ be as high as possible, being 99.9% by mass or greater and it is more preferable that it be 99.99% by mass or greater. Also, it is preferable that AlX₃ contain no impurity that exhibits the same equilibrium gas pressure as AlX₃ at the reaction temperature. In particular, it is preferable that AlX₃ have few elements such as B or P.

The impurity that can be removed from the material by bringing the aforementioned material to be purified into contact with AlX₃ will now be explained.

Bringing the material containing a metalloid element or metal element as the main component, and an impurity into contact with the compound represented by formula (1) causes the reaction represented by the following chemical equations (2) and (3).

M(p)+AlX₃ [symbol] MXₚ+AlXₘ (2)

M′(q)+AlX₃ [symbol] M′X_{q}+AlXₘ (3)

In chemical equation (2), M represents the metalloid element or metal element as the main component of the material, and p represents the valency of the main component M. In chemical equation (3), M′ represents an impurity element in the material and q represents the valency of the impurity. X represents a halogen atom, and m is 2 or 1, which represents the valency of Al after reduction.

When the impurity M′ is a metal, the valency q of the impurity element will vary depending on the reaction temperature and the type of metal. Alkali metals such as lithium or sodium have a value of q=1, Group 2 elements and alkaline earth metals such as magnesium and calcium, as well as vanadium and zinc, have a value of q=2, zirconium has a value of q=4, titanium has values of q=3 and 4, and aluminum, lead, tin, manganese, iron, nickel, chromium, gallium, indium, copper, titanium and rare earth metals have multiple values of q=1-3. When the impurity M′ is a metalloid element, silicon and germanium have values of q=1-3. Boron also becomes a chloride by a similar reaction. Boron has a value of q=3.

The Gibbs' free energy in the equilibrium reaction represented by chemical equation (2) is defined as ΔG_{M}, and the Gibbs' free energy in the equilibrium reaction represented by chemical equation (3) is defined as ΔG_{M′}. The units used for the Gibbs' free energy are kJ/mol. When the values of ΔG_{M} and ΔG_{M′} in the two equilibrium reactions are compared, it is found that the reaction with a lower value proceeds more easily to the right direction. When ΔG_{M′} is less than 0, the reaction of chemical equation (3) occurs spontaneously, and this is therefore preferred.

Thus, the conditions allowing efficiently removal of the impurity M′ from the main component M can be largely classified into the following four conditions, in terms of (ΔG_{M}−ΔG_{M}) and ΔG_{M}.
Condition (A): The following inequality (4) and the following inequality (5) are satisfied.
Condition (B): The following inequality (6) and the following inequality (5) are satisfied.
Condition (C): The following inequality (4) and the following inequality (7) are satisfied.
Condition (D): The following inequality (6) and the following inequality (7) are satisfied.

ΔG_{M′}−ΔG_{M}<0 (4)

ΔG_{M′}<0 (5)

0≦ΔG_{M′}−ΔG_{M}≦100 (6)

0≦ΔG_{M′}≦50 (7)

Each condition will now be explained.

[Condition (A)]

If the main component M and impurity M′ are in a combination satisfying condition (A), i.e. inequality (4) and inequality (5) above, it is possible to efficiently remove the impurity M′ from the material containing M as the main component, and to purify the material.

Specifically, when AlX₃ represented by formula (1) above is brought into contact with the material containing the metalloid element M or metal element M as the main component and the impurity M′, the AlX₃ comprising trivalent Al is reduced to AlX₂ comprising divalent Al and MX comprising monovalent Al, represented by MXₘ, while the main component M is oxidized to MXₚ by the reaction of chemical equation (2) and the impurity M′ is oxidized to M′X_{q} by the reaction of chemical equation (3). Because the main component M and impurity M′ are in a combination satisfying inequality (4), the proportion of M′X_{q} product relative to the reactant M′ tends to be greater than the proportion of MXₚ product relative to the reactant M. Stated differently, the main component M produces the halides MXₚ with greater difficulty than the impurity M′, and therefore the unreacted substance M tends to remain. Furthermore, because inequality (5) is satisfied, the reaction toward the right of chemical equation (3) tends to occur spontaneously.

Since the physical properties such as melting point and boiling point of the produced M′X_{q}, MXₚ, AlXₘ and unreacted AlX₃ differ significantly from the physical properties of the main component M, it is possible to easily separate and remove the M′X_{q}, MXₚ, AlXₘ and AlX₃ from the material containing M as the main component. In addition, the M′X_{q} and AlXₘ which are the main products have low reactivity for the main component element M, and the metalloid element M or metal element M to be purified is not easily halogenated by the AlX₃, M′X_{q} and AlXₘ. This allows purification of the material containing the metalloid element M or metal element M as the main component. That is, it is possible to efficiently remove the impurity M′ from the metalloid element M or metal element M as the main component, and obtain the metalloid element M or metal element M at high purity, without using a complex procedure such as repeated reduction.

[Condition (B)]

Even when the main component M and impurity M′ do not satisfy condition (A), so long as the main component M and impurity M′ are in a combination satisfying condition (B), i.e. inequalities (6) and (5) above, it is possible to remove the impurity M′ from the material containing M as the main component, albeit with lower efficiency than condition (A). In this case, since inequality (4) is not satisfied, the proportion of the product M′X_{q} relative to the reactant M′ will presumably tend to be lower than the proportion of the product MXₚ relative to the reactant M, but since inequality (6) is satisfied, presumably the ratios of the reaction of chemical equation (2) and chemical equation (3) are believed to be essentially equal to each other, and since inequality (5) is also satisfied, reaction of the impurity M′ according to chemical equation (3) proceeds spontaneously.

[Condition (C)]

Even when the main component M and impurity M′ do not satisfy condition (A), so long as the main component M and impurity M′ are in a combination satisfying condition (C), i.e. inequalities (4) and (7) above, it is possible to remove M′ from the material containing M as the main component, albeit with lower efficiency than condition (A). In this case, the reaction of chemical equation (3) does not easily occur spontaneously since inequality (5) is not satisfied, but since inequality (7) is satisfied, blowing in excess AlX₃ would allow removal of the small amount of impurity M′ that is present, despite some loss of the metalloid atom M or metal atom M. The ease of removal is approximately the same as condition (B).

[Condition (D)]

Even when the main component M and impurity M′ do not satisfy any of the conditions (A), (B) or (C), so long as the main component M and impurity M′ are in a combination satisfying condition (D), i.e. inequalities (6) and (7) above, it is possible to remove M′ from the material containing M as the main component, albeit with lower efficiency than conditions (B) and (C). In this case, since inequality (6) is satisfied, the ratios of the reaction of chemical equation (2) and chemical equation (3) are believed to be essentially equal to each other, and since inequality (7) is satisfied, blowing in excess AlX₃ would allow removal of the small amount of impurity M′ that is present.

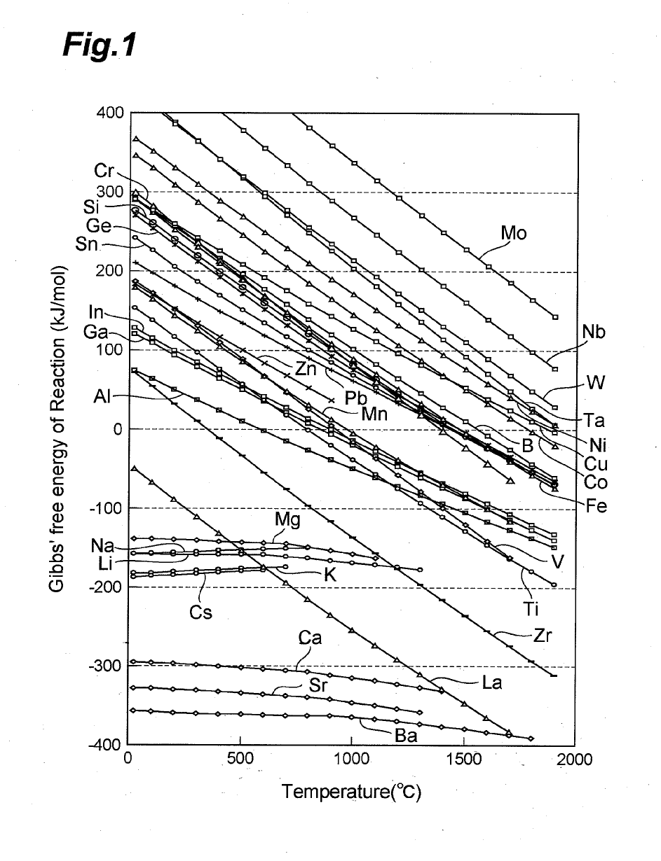

The impurity element M′ that can be removed from the material containing M as the main component element will now be described in detail, with reference to FIG. 1. FIG. 1 shows the Gibbs' free energy of Reaction ΔG [kJ/mol] at different reaction temperatures, between each element and AlX₃(X═Cl).

The Gibbs' free energy of Reaction ΔG [kJ/mol] is the change in Gibbs energy before and after the reaction represented by the following chemical equation (8).

Q(n)+nAlCl₃ [symbol] QClₙ+nAlCl₂ (8)

In the equation, Q represents each element and n represents the valency of each element Q.

In cases where each element Q can adopt a different valency n depending on the reaction temperature range, the Gibbs' free energy of Reaction ΔG_{Q} was determined for QClₙ which exists most stably in each range.

FIG. 1 shows the Gibbs' free energy ΔG_{Q} for halogenation reaction at different temperatures, for each element Q. The element Q is lithium, sodium, potassium, cesium, magnesium, calcium, strontium, barium, boron, aluminum, gallium, indium, silicon, germanium, tin, lead, titanium, zirconium, vanadium, niobium, tantalum, chromium, molybdenum, tungsten, manganese, iron, cobalt, nickel, copper, zinc or lanthanum.

As shown in chemical equation (8), the halogenation reaction for each element Q assumes halogenation (oxidation) by reduction of AlCl₃ to AlCl₂. Thus, the removed impurity can be determined under conditions in which the AlCl₂ produced is disproportionated to Al and AlCl₃ and Al does not remain in the material as a new impurity. Specifically, the magnitude relationship between the changes in Gibbs' free energy of Reaction of two elements, among the different elements Q, is weighed in a temperature range of 600° C. and higher at which the change in Gibbs' free energy of Reaction of ΔG_{Al}≦0 for the equilibrium reaction of the following chemical equation (9):

Al+AlCl₃ [symbol] 2AlCl₂ (9)

and the combinations of the main component and the impurity that can be removed are determined.

The impurity element M′ that can be removed from a material containing silicon as the main component will now be described.

The alkali metals lithium, sodium, potassium and cesium satisfy condition (A) in the temperature range of 600° C. and higher, and can therefore be easily removed from silicon. Since the boiling point of lithium is approximately 1350° C., that of sodium is approximately 883° C., that of potassium is approximately 774° C. and that of cesium is approximately 678° C., each metal can be vaporized and removed at the respective boiling point or higher, without bringing the AlX₃ into contact with the material for halogenation.

Magnesium as a Group 2 element, and the alkaline earth metals calcium, strontium and barium as Group 2 elements, can also be easily removed from silicon since they satisfy condition (A) in the temperature range of 600° C. and higher. Since the boiling point of magnesium is approximately 1090° C., that of calcium is approximately 1480° C., that of strontium is approximately 1380° C. and that of barium is approximately 1640° C., each metal can be vaporized and removed at the respective boiling point or higher, without bringing the AlX₃ into contact with the material for halogenation. Nevertheless, magnesium reacts with silicon so that it exists stably at high temperature as the silicide MgSi₂, but this can also be removed with AlCl₃, as described below.

The rare earth metal lanthanum also satisfies condition (A) in a temperature range of 600° C. or greater and not greater than 1900° C., and is therefore preferred as it can be easily removed from silicon.

Zirconium and aluminum satisfy condition (A) in a temperature range of 600° C. or greater and not greater than 1900° C., and are therefore preferred as they can be easily removed from silicon.

Condition (C) is satisfied by titanium in a temperature range of 600° C. or higher and less than 800° C., gallium and indium at 600° C. or higher and less than 900° C., vanadium at 700° C. or higher and less than 950° C., manganese at 700° C. or higher and less than 1000° C., zinc at 850° C. or higher and not higher than 900° C. and tin at 1150° C. or higher and less than 1450° C., and these can therefore be removed from silicon. Also, condition (A) is satisfied by titanium at 800° C. or higher and not higher than 1900° C., gallium and indium at 900° C. or higher and not higher than 1900° C., vanadium at 950° C. or higher and not higher than 1700° C., manganese at 1000° C. or higher and not higher than 1700° C. and tin at 1450° C. or higher and not higher than 1900° C., and therefore these are preferred for the impurity M to be removed from silicon.

Zinc has a boiling point of approximately 907° C., and therefore it can be removed at the boiling point or higher without bringing AlX₃ into contact with the material for halogenation. Also, zinc chloride is stable near the melting point of silicon (approximately 1410° C.), and since the boiling point of the chloride is sufficiently lower than the melting point of silicon, it can be easily removed from the material as zinc chloride vapor.

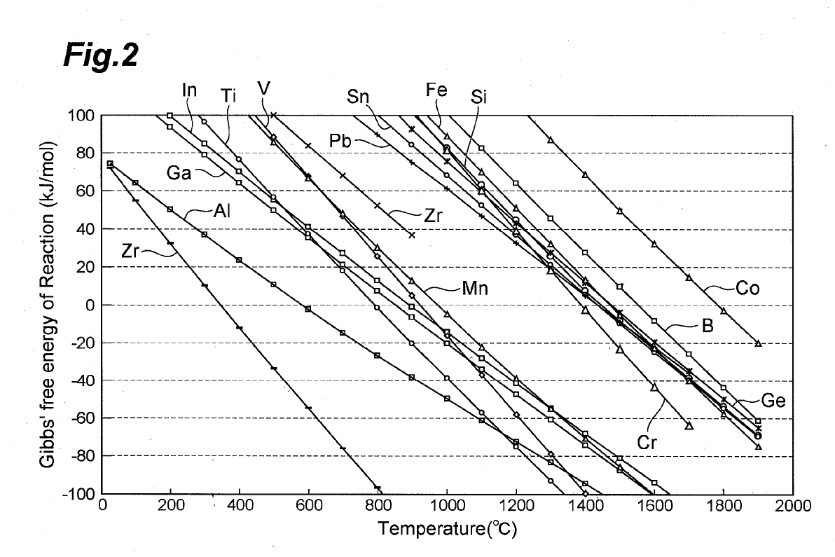

Lead, germanium, iron and chromium will now be explained with reference to FIG. 2, which is a magnified view of a region of the graph showing ΔG_{M(Si)} for silicon.

Lead satisfies inequality (4): ΔG_{M′(Pb)}−ΔG_{M(Si)}<0 in the temperature range of 600° C. or higher and less than 1100° C., but since ΔG_{M′(Pb)}>50 (kJ/mol), it is difficult to remove from silicon in this temperature range. Condition (B) is satisfied in the temperature range of 1100° C. or higher and less than 1450° C., thus allowing removal from silicon. Also, condition (A) is satisfied at 1450° C. or higher and less than 1500° C., thus allowing efficient removal, while condition (C) is satisfied at 1500° C. or higher and not higher than 1700° C., thus allowing removal.

Germanium satisfies inequality (4): ΔG_{M′(Ge)}−ΔG_{M(Si)}<0 in the temperature range of 600° C. or higher and less than 1150° C., but since ΔG_{M′(Ge)}>50 (kJ/mol), it is difficult to remove from silicon in this temperature range. Condition (C) is satisfied in the temperature range of 1150° C. or higher and less than 1250° C., thus allowing removal, and condition (D) is satisfied at 1250° C. or higher and less than 1500° C., thus allowing removal. Also, condition (B) is satisfied in the temperature range of 1500° C. or higher and not higher than 1900° C., and therefore more efficient removal can be accomplished, including lowering the amount of AlX₃ used, for example, compared to removal in a range of 1250° C. or higher and less than 1500° C.

Iron satisfies the inequality ΔG_{M′(Fe)}>50 (kJ/mol) in the temperature range of 600° C. or higher and less than 1200° C., and therefore its removal is difficult. However, condition (D) is satisfied at 1200° C. or higher and less than 1500° C., thus allowing removal. Condition (B) is satisfied at 1500° C. or higher and less than 1650° C., thus rendering removal easier. Condition (A) is satisfied at 1650° C. or higher and not higher than 1900° C., thus allowing more efficient removal of impurities.

Chromium satisfies the inequality ΔG_{M′(Cr)}>50 (kJ/mol) in the temperature range of 600° C. or higher and less than 1150° C., and therefore its removal is difficult. However, condition (C) is satisfied at 1150° C. or higher and less than 1400° C., thus allowing removal, while condition (A) is satisfied in the temperature range of 1400° C. or higher and not higher than 1700° C., thus allowing efficient removal from silicon.

Boron satisfies the inequality ΔG_{M′(B)}>50 (kJ/mol) in the temperature range of 600° C. or higher and less than 1300° C., and therefore its removal is difficult. However, condition (D) is satisfied in the temperature range of 1300° C. or higher and less than 1550° C., thus allowing removal. Condition (B) is satisfied at 1550° C. or higher and not higher than 1900° C., and therefore more efficient removal can be accomplished compared to the temperature range of 1300° C. or higher and less than 1550° C.

Copper satisfies the inequality ΔG_{M′(Cu)}>50 (kJ/mol) at 600° C. or higher and less than 1550° C., and therefore its removal is difficult. Condition (D) is satisfied at 1550° C. or higher and less than 1900° C., thus allowing removal.

Nickel satisfies the inequality ΔG_{M′(Ni)}>50 (kJ/mol) at 600° C. or higher and less than 1650° C., and therefore its removal is difficult. Condition (D) is satisfied at 1650° C. or higher and less than 1900° C., thus allowing removal.

The impurity element M′ that can be removed from a material containing germanium as the main component will now be described.

As shown in FIG. 2, the temperature-ΔG_{Ge} line for germanium is located near the temperature-ΔG_{Si} line for silicon. As explained above, the impurity element M′ that can be removed from a material containing element M as the main component is determined based on the magnitude relationship between ΔG_{M′} and ΔG_{M}, and on the size of the absolute value of ΔG_{M′} and the energy difference between ΔG_{M′} and ΔG_{M}. Consequently, an impurity element M′ that can be removed from a material containing silicon as the main component, can generally be removed from a material containing germanium as the main component. Examples of impurities that can be removed in this case include lithium, sodium, potassium, cesium, magnesium, calcium, strontium, barium, boron, aluminum, gallium, indium, tin, titanium, zirconium, vanadium, manganese, copper, nickel, zinc, lead, silicon, iron and chromium. In addition, cobalt which forms an alloy with silicon and thus becomes difficult to remove from silicon, does not form an alloy with germanium, and can therefore be removed from a material containing germanium as the main component.

The suitable conditions for removal of each impurity M′ are generally the same as for removal from a material containing silicon as the main component, but cases which are somewhat different from removal from a material containing silicon as the main component, and which have not hitherto been discussed, will now be mentioned.

Lead is an element M′ that satisfies condition (C) in the temperature range of 1100° C. or higher and less than 1450° C., and it can therefore be removed from germanium. Also, condition (A) is satisfied at 1450° C. or higher and not higher than 1700° C., thus allowing efficient removal.

Silicon satisfies the inequality ΔG_{M′(Si)}>50 (kJ/mol) in the temperature range of 600° C. or higher and less than 1200° C., and therefore its removal is difficult. However, condition (D) is satisfied in the temperature range of 1200° C. or higher and less than 1250° C., thus allowing removal. Also, condition (C) is satisfied at 1250° C. or higher and less than 1500° C., thus allowing still easier removal, and condition (A) is satisfied at 1500° C. or higher and not higher than 1900° C., thus allowing more efficient removal.

Iron satisfies condition (D) in the temperature range of 1200° C. or higher and less than 1500° C., thus allowing its removal. Condition (A) is satisfied at 1500° C. or higher and not higher than 1900° C., thus allowing efficient removal.

Chromium satisfies condition (C) at 1150° C. or higher and less than 1400° C., thus allowing its removal, while it satisfies condition (A) in the temperature range of 1400° C. or higher and not higher than 1700° C., thus allowing its efficient removal.

Cobalt satisfies the inequality ΔG_{M′(Co)}>50 (kJ/mol) in the temperature range of 600° C. or higher and less than 1500° C., and therefore its removal is difficult. Condition (D) is satisfied in the temperature range of 1500° C. or higher and less than 1800° C., thus allowing removal. Also, condition (B) is satisfied at 1800° C. or higher and not higher than 1900° C., thus allowing removal. However, a temperature of 1900° C. or higher is not practical as this also results in high loss of germanium.

The impurity element M′ that can be removed from a material containing copper as the main component will now be described.

As shown in FIG. 1, the temperature-ΔG_{Cu} line for copper is located above the temperature-ΔG_{Ge} line for germanium and the temperature-ΔG_{Si} line for silicon. Thus, an impurity element M′ that can be removed from a material containing silicon as the main component and a material containing germanium as the main component can be removed from a material containing copper as the main component.

Examples of impurities that can be removed in this case include lithium, sodium, potassium, cesium, magnesium, calcium, strontium, barium, aluminum, gallium, indium, tin, titanium, zirconium, vanadium, manganese, zinc, lanthanum, silicon, germanium, lead, iron, boron, chromium, cobalt and nickel. The suitable conditions for removal of each impurity M′ are generally the same as for removal of each impurity M′ from a material containing silicon as the main component or removal from a material containing germanium as the main component, but cases which are somewhat different from those mentioned above and which have not hitherto been discussed, will now be mentioned.

Condition (C) is satisfied by lead in the temperature range of 1100° C. or higher and less than 1450° C., germanium at 1150° C. or higher and less than 1500° C., silicon at 1200° C. or higher and less than 1500° C., iron at 1200° C. or higher and less than 1500° C., boron at 1300° C. or higher and less than 1550° C., chromium at 1150° C. or higher and less than 1400° C. and cobalt at 1500° C. or higher and less than 1800° C., thus allowing their removal from copper. Also, nickel satisfies condition (D) in the temperature range of 1650° C. or higher and not higher than 1900° C., and can therefore be removed.

In addition, since condition (A) is satisfied by chromium at 1400° C. or higher and not higher than 1700° C., lead at 1450° C. or higher and not higher than 1700° C., silicon, germanium and iron at 1500° C. or higher and not higher than 1900° C., boron at 1550° C. or higher and not higher than 1900° C. and cobalt at 1800° C. or higher and not higher than 1900° C., these are preferred as the impurity M′ to be removed from copper.

The impurity element M′ that can be removed from a material containing nickel as the main component will now be described.

As shown in FIG. 1, the temperature-ΔG_{Ni} line for nickel is located further above the temperature-ΔG_{Cu} line for copper. Thus, an impurity element M′ that can be removed from a material containing silicon as the main component, a material containing germanium as the main component or a material containing copper as the main component can be removed from a material containing nickel as the main component.

Examples of impurities that can be removed in this case include lithium, sodium, potassium, cesium, magnesium, calcium, strontium, barium, boron, aluminum, gallium, indium, tin, titanium, zirconium, vanadium, manganese, lead, germanium, silicon, iron, zinc, chromium, cobalt and copper. The suitable conditions for removal of each impurity M′ are generally the same as for removal of each impurity M′ from a material containing silicon as the main component, but cases which are somewhat different from those mentioned above and which have not hitherto been discussed, will now be mentioned.

Copper satisfies condition (C) in the temperature range of 1550° C. or higher and not higher than 1900° C., and can therefore be removed from nickel.

There are no particular restrictions on the amount of the element of an impurity M′ other than the element M as the main component, but it is preferable that it be no greater than 5% by mass, for example.

Such a material containing a metalloid element M or metal element M as the main component and containing an impurity M′ may be, specifically, a metalloid element material obtained by reduction of a metalloid element chloride gas with a metal such as sodium or aluminum or with hydrogen, or a metal material obtained by oxidizing smelting, electrolytic refining, carbon reduction or the like. These include silicon materials e.g. silicon scrap, obtained by reducing silicon chloride gas such as silicon tetrachloride with metals such as aluminum and metal materials such as germanium obtained by reduction from chlorides and copper or nickel obtained by oxidizing smelting or electrolytic refining. For a silicon material, it is normally possible to efficiently purify silicon with a purity of 97% by mass or greater and preferably 99% by mass or greater and not greater than 99.99% by mass, which is known as “metallurgical grade”.

In the case of silicon, for example, such materials contain impurities such as lithium, sodium, potassium, beryllium, magnesium, calcium, strontium, barium, zirconium, aluminum, titanium, gallium, indium, vanadium, manganese, chromium, tin, lead, germanium, iron, boron, zinc, copper, nickel and rare earth metals.

In the case of germanium, such materials contain impurities such as lithium, sodium, potassium, beryllium, magnesium, calcium, strontium, barium, zirconium, aluminum, titanium, gallium, indium, vanadium, manganese, chromium, tin, lead, silicon, iron, boron, cobalt, zinc, copper, nickel and rare earth metals.

In the case of copper, such materials contain impurities such as lithium, sodium, potassium, beryllium, magnesium, calcium, strontium, barium, zirconium, aluminum, titanium, gallium, indium, vanadium, manganese, chromium, tin, lead, silicon, germanium, iron, cobalt, boron, zinc, nickel and rare earth metals.

In the case of nickel, such materials contain impurities such as lithium, sodium, potassium, beryllium, magnesium, calcium, strontium, barium, zirconium, aluminum, titanium, gallium, indium, vanadium, manganese, chromium, tin, lead, silicon, germanium, iron, cobalt, copper, boron, zinc and rare earth metals.

When AlF₃ is used as the AlX₃, for purification of a material containing silicon as the main component, for example, it is possible to remove lithium, beryllium, sodium, potassium, cesium, magnesium, calcium, strontium, barium, boron, aluminum, gallium, indium, titanium, manganese, lead and lanthanum.

When AlBr₃ is used as the AlX₃, for purification of a material containing silicon as the main component, for example, it is possible to remove lithium, beryllium, sodium, potassium, cesium, magnesium, calcium, strontium, barium, aluminum, gallium, indium, germanium, tin, lead, manganese, iron, titanium and lanthanum.

For removal of a reaction product from a material, since the melting points or boiling points of the halides are significantly lower than the material containing the metalloid element or metal element as the main component, it is possible, for example, to liquefy the material and separate the halide as a gas, or to solidify the material and separate the halide as a gas or liquid.

By bringing AlCl₃ into contact with the material containing a metalloid element or metal element as the main component in a heated molten state, for example, the AlCl₃ reacts with the impurity in the material to produce AlCl₂ and AlCl, while also producing the impurity chlorides M′Cl_{q}. For example, when the impurities are alkali metals such as lithium, sodium, potassium, rubidium or cesium, Group 2 elements such as beryllium, magnesium, calcium, strontium or barium, alkaline earth metals and rare earth metals, their chlorides tend to become molten liquid, and when molten liquid, they form a molten liquid phase that is different from the molten liquid phase of the material containing the metalloid element as the main component, thus allowing easy separation. For example, after the phase separated liquid has cooled, the solid may be rinsed so that the chloride such as an alkali metal chloride, Group 2 element chloride, alkaline earth metal chloride or rare earth metal chloride can be easily dissolved in water and separated.

When the impurity is aluminum, gallium, indium, germanium, tin, lead, iron, nickel, chromium, copper, titanium, zinc, boron, silicon or the like, their chlorides have high vapor pressure and it is easy to remove them into gas phase together with aluminum subhalides (gases). The purification procedure is therefore very convenient.

Materials containing a metalloid element or metal element as the main component and also an impurity, which can be purified by the invention, are not limited to the materials mentioned above. For any combination of a main component M and impurity M′ that satisfies condition (A), condition (B), condition (C) or condition (D) specified above, the impurity M′ can be removed from the main component M. Particularly when condition (A) is satisfied, the impurity M′ can be very efficiently removed and the material containing M as the main component can be very efficiently purified. In Table 1 only the main reaction formulas of chemical equations (2) and (3) are considered, but when an intermetallic compound is produced between M and M′, the equilibrium of the system may be significantly affected by other reaction formulas and equilibrium constants. However, Table 1 provides a sufficiently reasonable measure for the ability to purify the main component M and impurity M′.

Incidentally, purification of the metalloid element M or metal element M as the main component involves causing halogenation reaction of the impurity element M′ to occur at higher frequency than halogenation reaction of the main component M, in an equilibrium reaction in the system in which the main component element M and impurity element M′ are copresent. That is, the impurity element M′ halides are produced in greater amount than the main component M halides. However, in some cases it is not always possible to produce the impurity element M′ halides in greater amount than the main component M halides. Nevertheless, the actual amount of the impurity element M′ can be reduced before and after the reaction, and it may be said that the impurity can be removed.

The equilibrium composition in a system containing silicon as the main component, an impurity element M′ and AlX₃ was calculated next. The composition of chemical species in a reaction system that has reached equilibrium at a prescribed reaction temperature can be determined by calculation based on the equilibrium constant. Here, the thermodynamic database MALT (MALT group, sold by Kagaku Gijutsu-Sha) was used to calculate the equilibrium constant so as to minimize free energy of the entire system, and compositions AlX₃, AlX₂, AlX, M, MXₚ, M′, M′X_{q} and the like were determined.

### CALCULATION EXAMPLES A-1 TO A-9

### Silicon-Aluminum-AlCl₃ System

A case with silicon (p=1-3) as the metalloid element, aluminum (q=1-3) as the impurity and AlCl₃ as AlX₃ was considered. The main component silicon is halogenated to produce SiCl₃, SiCl₂ and SiCl, the impurity Al produces AlCl₃, AlCl₂ and AlCl, and AlCl₃ is reduced to produce AlCl₂ and AlCl.

For Calculation Examples A-1 to A-9, the chemical composition at equilibrium was calculated for silicon, aluminum and AlCl₃, at the molar ratios and temperatures shown in Table 1, in each system assumed to be at atmospheric pressure. The results are shown in Table 2.

TABLE 1

| | Main | Impurity | | AlCl₃/Al | |
|---|---|---|---|---|---|
| Calculation | component M | element M′ | AlCl₃ | molar | Temp. |
| Ex. | Si (mol) | Al (mol) | (mol) | ratio | (° C.) |
| A-1 | 95 | 5 | 5 | 1 | 1450 |
| A-2 | 95 | 5 | 5 | | 1500 |
| A-3 | 95 | 5 | 5 | | 1550 |
| A-4 | 95 | 5 | 7.5 | 1.5 | 1450 |
| A-5 | 95 | 5 | 7.5 | | 1500 |
| A-6 | 95 | 5 | 7.5 | | 1550 |
| A-7 | 95 | 5 | 10 | 2 | 1450 |
| A-8 | 95 | 5 | 10 | | 1500 |
| A-9 | 95 | 5 | 10 | | 1550 |

TABLE 2

| | Al | | | | | | | Al |
|---|---|---|---|---|---|---|---|---|
| Calculation | (liquid) | Si | SiCl₃ | SiCl₂ | AlCl₃ | AlCl₂ | AlCl | (gas) |
| Ex. | (mol) | (mol) | (mol) | (mol) | (mol) | (mol) | (mol) | (mol) |
| A-1 | 0.848 | 95 | 0 | 0 | 0.0245 | 5.801 | 3.324 | 0.003 |
| A-2 | 0.49 | 95 | 0 | 0.0002 | 0.0193 | 5.458 | 4.025 | 0.0056 |
| A-3 | 0.099 | 95 | 0 | 0.0002 | 0.015 | 5.079 | 4.797 | 0.01 |
| A-4 | 0 | 95 | 0 | 0.0011 | 0.0902 | 9.819 | 2.59 | 0.001 |
| A-5 | 0 | 95 | 0 | 0.002 | 0.0963 | 9.804 | 2.598 | 0.001 |
| A-6 | 0 | 95 | 0 | 0.004 | 0.102 | 9.789 | 2.607 | 0.002 |
| A-7 | 0 | 94.965 | 0.001 | 0.034 | 0.637 | 13.654 | 0.709 | 0 |
| A-8 | 0 | 94.94 | 0.0019 | 0.058 | 0.636 | 13.606 | 0.758 | 0 |
| A-9 | 0 | 94.9 | 0.003 | 0.092 | 0.625 | 13.555 | 0.82 | 0 |

It is seen that at a reaction temperature of 1450° C.-1550° C., for all of the Calculation Examples, virtually no loss of silicon occurs and the aluminum impurity is selectively converted to chloride (aluminum subhalide) gas and removed. In particular, using a 1.5-2 fold molar amount of AlCl₃ relative to aluminum can remove almost all of the aluminum from silicon.

### CALCULATION EXAMPLES B-1 TO B-6

### Silicon-Elemental Species Other than Aluminum (1)-AlCl₃ System

Equilibrium calculation was also performed in the same manner as Calculation Example A-1, under the conditions shown in Table 3. As impurities in silicon at a reaction temperature of 1350° C.-1500° C., there were used the Group 2 element beryllium, the Group 2 element magnesium, which is in gas phase in the expected temperature range, as magnesium silicide which is an alloy of magnesium and silicon that is stable as a solid phase, and calcium, strontium and barium which are Group 2 elements and also alkaline earth metals. The results are shown in Table 4. It is seen that chlorination of the impurity elements proceeds selectively even with a roughly equimolar amount of AlCl₃ relative to the impurities.

TABLE 3

| | | | | | AlCl₃/M′ | |
|---|---|---|---|---|---|---|
| Calculation | Si | Impurity | M′ | AlCl₃ | molar | Temp. |
| Ex. | (mol) | element M′ | (mol) | (mol) | ratio | (° C.) |
| B-1 | 100 | Be | 1 | 5 | 5 | 1450 |
| B-2 | 99 | MgSi₂ | 1 | 5 | 5 | 1500 |
| B-3 | 100 | Ca | 1 | 1.5 | 1.5 | 1450 |
| B-4 | 100 | Ca | 1 | 5 | 5 | 1450 |
| B-5 | 100 | Sr | 1 | 5 | 5 | 1350 |
| B-6 | 100 | Ba | 1 | 5 | 5 | 1450 |

TABLE 4

| | | M′ | | | | | | | | | | | |
|---|---|---|---|---|---|---|---|---|---|---|---|---|---|
| | | (solid | | | | | | | | | | | M′ |
| Calculation | Impurity | or liquid) | M′Siₓ | Si | SiCl₃ | SiCl₂ | AlCl₃ | AlCl₂ | AlCl | M′Cl₃ | M′Cl₂ | M′Cl | (gas) |
| Ex. | element M′ | (mol) | (mol) | (mol) | (mol) | (mol) | (mol) | (mol) | (mol) | (mol) | (mol) | (mol) | (mol) |
| B-1 | Be | 0 | 0 | 99.2 | 0.137 | 0.678 | 1.17 | 3.799 | 0.03 | — | 0.997 | — | — |
| B-2 | MgSi₂ | 0 | 0 | 99.76 | 0.02 | 0.223 | 0.575 | 4.34 | 0.085 | — | 1.989 | — | — |
| B-3 | Ca | 0 | 0 | 100 | 0 | 0 | 0.005 | 0.99 | 0.5 | — | 1 | — | — |
| B-4 | Ca | 0 | 0 | 99.2 | 0.138 | 0.65 | 1.22 | 3.76 | 0.03 | — | 1 | — | — |
| B-5 | Sr | 0 | 0 | 99.4 | 0.122 | 0.415 | 1.67 | 3.31 | 0.01 | — | 1 | — | — |
| B-6 | Ba | 0 | 0 | 99.17 | 0.138 | 0.659 | 1.2 | 3.77 | 0.03 | — | 1 | — | — |

### CALCULATION EXAMPLES C-1 TO C-37

### Silicon-Elemental Species Other than Aluminum (2)-AlCl₃ System

Gallium, indium, germanium, tin, lead, boron, iron, nickel, chromium, titanium, copper, zinc, manganese, zirconium and vanadium were employed as impurity elements, and equilibrium calculation was performed in the same manner as Calculation Example A-1 under the conditions shown in Table 5. The impurities are removed by reaction between the silicon containing the impurities and the prescribed amount of AlCl₃. This is clear from the results of Calculation Examples C-1 to C-37 shown in Tables 5 and 6 below.

TABLE 5

| | | | | | AlCl₃/M′ | |
|---|---|---|---|---|---|---|
| Calculation | Si | Impurity | M′ | AlCl₃ | molar | Temp. |
| Ex. | (mol) | element M′ | (mol) | (mol) | ratio | (° C.) |
| C-1 | 100 | Ga | 0.1 | 5 | 50 | 1500 |
| C-2 | 100 | In | 0.1 | 5 | 50 | 1450 |
| C-3 | 100 | Ge | 0.01 | 5 | 500 | 1200 |
| C-4 | 100 | Ge | 0.1 | 5 | 50 | 1450 |
| C-5 | 100 | Sn | 0.01 | 5 | 500 | 1200 |
| C-6 | 99 | Sn | 1 | 5 | 5 | 1500 |
| C-7 | 100 | Pb | 0.01 | 5 | 500 | 1200 |
| C-8 | 99 | Pb | 1 | 5 | 5 | 1500 |
| C-9 | 100 | B | 0.01 | 5 | 500 | 1450 |
| C-10 | 100 | B | 0.01 | 5 | 500 | 1500 |
| C-11 | 99.9 | Fe | 0.1 | 5 | 50 | 1500 |
| C-12 | 99.9 | Fe | 0.1 | 5 | 50 | 1600 |
| C-13 | 99.99 | Fe | 0.01 | 5 | 500 | 1500 |
| C-14 | 99.99 | Fe | 0.01 | 5 | 500 | 1600 |
| C-15 | 99.99 | Ni | 0.01 | 5 | 500 | 1500 |
| C-16 | 99.99 | Ni | 0.01 | 5 | 500 | 1600 |
| C-17 | 100 | Cr | 0.1 | 5 | 50 | 1500 |
| C-18 | 100 | Cr | 0.1 | 5 | 50 | 1600 |
| C-19 | 100 | Cr | 0.01 | 5 | 500 | 1600 |
| C-20 | 100 | Ti | 0.01 | 5 | 500 | 1200 |
| C-21 | 100 | Ti | 0.1 | 5 | 50 | 1500 |
| C-22 | 100 | Ti | 0.1 | 5 | 50 | 1600 |
| C-23 | 100 | Cu | 0.01 | 5 | 500 | 1200 |
| C-24 | 100 | Cu | 0.1 | 5 | 50 | 1500 |
| C-25 | 100 | Cu | 0.1 | 5 | 50 | 1600 |
| C-26 | 100 | Zn | 0.1 | 5 | 50 | 1500 |
| C-27 | 100 | Zn | 0.01 | 5 | 500 | 1500 |
| C-28 | 100 | Zn | 0.01 | 5 | 500 | 1600 |
| C-29 | 100 | Mn | 0.1 | 5 | 50 | 1500 |
| C-30 | 100 | Mn | 0.01 | 5 | 500 | 1500 |
| C-31 | 100 | Mn | 0.01 | 5 | 500 | 1600 |
| C-32 | 100 | Zr | 0.1 | 5 | 50 | 1500 |
| C-33 | 100 | Zr | 0.01 | 5 | 500 | 1500 |
| C-34 | 100 | Zr | 0.01 | 5 | 500 | 1600 |
| C-35 | 100 | V | 0.1 | 5 | 50 | 1500 |
| C-36 | 100 | V | 0.01 | 5 | 500 | 1500 |
| C-37 | 100 | V | 0.01 | 5 | 500 | 1600 |

TABLE 6

| | | M′ | | | | | | | | | | | | |
|---|---|---|---|---|---|---|---|---|---|---|---|---|---|---|
| | | (solid or | | | | | | | | | | | | M′ |
| Calculation | Impurity | liquid) | M′Siₓ | Si | SiCl₃ | SiCl₂ | AlCl₃ | AlCl₂ | AlCl | M′CL₄ | M′Cl₃ | M′Cl₂ | M′Cl | (gas) |
| Ex. | element M′ | (mol) | (mol) | (mol) | (mol) | (mol) | (mol) | (mol) | (mol) | (mol) | (mol) | (mol) | (mol) | (mol) |
| C-1 | Ga | 0 | 0 | 98.3 | 0.298 | 1.296 | 1.235 | 3.735 | — | — | — | — | 0.097 | — |
| C-2 | In | 0 | 0 | 98.5 | 0.307 | 1.145 | 1.44 | 3.54 | — | — | — | — | 0.098 | — |
| C-3 | Ge | 0 | 0 | 99.3 | 0.206 | 0.305 | 2.926 | 2.052 | 0.0023 | — | — | 0.0085 | 0.0015 | — |
| C-4 | Ge | 0 | 0 | 98.5 | — | 1.13 | 1.43 | 3.54 | — | — | — | 0.06 | 0.04 | — |
| C-5 | Sn | 0 | 0 | 99.3 | 0.206 | 0.305 | 2.926 | 2.052 | 0.0023 | — | — | 0.0088 | 0.0012 | — |
| C-6 | Sn | 0 | 0 | 97.9 | 0.166 | 0.894 | 1.049 | 3.91 | 0.038 | — | — | 0.608 | 0.39 | — |
| C-7 | Pb | 0 | 0 | 99.3 | 0.206 | 0.305 | 2.926 | 2.052 | 0.0023 | — | — | 0.001 | 0.0075 | 0.0015 |
| C-8 | Pb | 0 | 0 | 97.6 | 0.236 | 1.145 | 1.135 | 3.83 | 0.03 | — | — | 0.05 | 0.663 | 0.29 |
| C-9 | B | 0 | 0 | 98.4 | 0.314 | 1.16 | 1.452 | 3.53 | 0.021 | — | 0.0095 | — | — | — |
| C-10 | B | 0 | 0 | 98.3 | 0.305 | 1.313 | 1.245 | 3.725 | 0.029 | — | 0.0093 | — | — | — |
| C-11 | Fe | 0 | 0.085 | 98.06 | 0.324 | 1.37 | 1.26 | 3.71 | 0.028 | — | — | 0.012 | — | — |
| C-12 | Fe | 0 | 0.079 | 97.85 | 0.288 | 1.65 | 0.917 | 4.03 | 0.053 | — | — | 0.021 | — | — |
| C-13 | Fe | 0 | 0 | 98.32 | 0.306 | 1.32 | 1.246 | 3.724 | 0.029 | — | — | 0.01 | — | — |
| C-14 | Fe | 0 | 0 | 98.09 | 0.274 | 1.589 | 0.907 | 4.04 | 0.053 | — | — | 0.01 | — | — |
| C-15 | Ni | 0 | 0.01 | 98.19 | 0.308 | 1.32 | 1.249 | 3.72 | 0.029 | — | — | — | — | — |
| C-16 | Ni | 0 | 0 | 98 | 0.274 | 1.59 | 0.908 | 4.04 | 0.053 | — | — | 0.007 | 0.003 | — |
| C-17 | Cr | 0 | 0.06 | 98.2 | 0.3 | 1.3 | 1.24 | 3.73 | 0.029 | — | — | 0.04 | — | — |
| C-18 | Cr | 0 | 0.026 | 98.1 | 0.263 | 1.55 | 0.9 | 4.05 | 0.054 | — | — | 0.074 | — | — |
| C-19 | Cr | 0 | 0 | 98.1 | 0.274 | 1.589 | 0.907 | 4.04 | 0.053 | — | — | 0.01 | — | — |
| C-20 | Ti | 0 | 0 | 99.3 | 0.206 | 0.305 | 2.926 | 2.052 | 0.0023 | 0.0032 | 0.0068 | — | — | — |
| C-21 | Ti | 0 | 0.051 | 98.3 | 0.29 | 1.28 | 1.23 | 3.74 | 0.029 | — | 0.04 | — | — | — |
| C-22 | Ti | 0 | 0 | 98.2 | 0.25 | 1.5 | 0.89 | 4.06 | 0.055 | — | 0.086 | — | — | — |
| C-23 | Cu | 0.0065 | 0 | 99.3 | 0.206 | 0.305 | 2.926 | 2.052 | 0.0023 | — | — | — | 0.032 | — |
| C-24 | Cu | 0.03 | 0 | 98.2 | 0.3 | 1.3 | 1.24 | 3.73 | 0.029 | — | — | — | 0.064 | — |
| C-25 | Cu | 0 | 0 | 98.1 | 0.268 | 1.57 | 0.9 | 4.05 | 0.054 | — | — | — | 0.094 | 0.005 |
| C-26 | Zn | 0 | 0 | 98.6 | 0.238 | 1.11 | 1.14 | 3.83 | 0.0317 | — | — | 0.007 | — | 0.093 |
| C-27 | Zn | 0 | 0 | 98.3 | 0.305 | 1.3 | 1.22 | 3.75 | 0.0285 | — | — | 0.0008 | — | 0.0092 |
| C-28 | Zn | 0 | 0 | 98.1 | 0.274 | 1.57 | 0.887 | 4.06 | 0.0526 | — | — | 0.0005 | — | 0.0095 |
| C-29 | Mn | 0 | 0 | 98.6 | 0.238 | 1.11 | 1.14 | 3.83 | 0.0317 | — | — | 0.0999 | — | — |
| C-30 | Mn | 0 | 0 | 98.3 | 0.305 | 1.3 | 1.22 | 3.75 | 0.0285 | — | — | 0.0999 | — | — |
| C-31 | Mn | 0 | 0 | 98.1 | 0.274 | 1.57 | 0.887 | 4.06 | 0.0526 | — | — | 0.0998 | — | — |
| C-32 | Zr | 0 | 0 | 98.6 | 0.238 | 1.11 | 1.14 | 3.83 | 0.0317 | 0.0999 | — | — | — | — |
| C-33 | Zr | 0 | 0 | 98.3 | 0.305 | 1.3 | 1.22 | 3.75 | 0.0285 | 0.0999 | — | — | — | — |
| C-34 | Zr | 0 | 0 | 98.1 | 0.274 | 1.57 | 0.887 | 4.06 | 0.0526 | 0.0998 | — | — | — | — |
| C-35 | V | 0 | 0 | 98.6 | 0.238 | 1.11 | 1.14 | 3.83 | 0.0317 | — | — | 0.1 | — | — |
| C-36 | V | 0 | 0 | 98.3 | 0.305 | 1.3 | 1.22 | 3.75 | 0.0285 | — | — | 0.01 | — | — |
| C-37 | V | 0 | 0 | 98.1 | 0.274 | 1.57 | 0.887 | 4.06 | 0.0526 | — | — | 0.01 | — | — |

When iron is to be removed, AlCl₃ (mol) may be blown in at 1500-1600° C., in at least a 50-fold molar amount, it is preferable that it be blown in at least a 200-fold molar amount and it is even more preferable that it be blown in at least a 500-fold molar amount, relative to the iron. When chromium is to be removed, AlCl₃ (mol) may be blown in at 1600° C., in at least a 50-fold molar amount, it is preferable that it be blown in at least a 200-fold molar amount and it is even more preferable that it be blown in at least a 500-fold molar amount, relative to the chromium. When nickel is to be removed, AlCl₃ (mol) may be blown in at 1600° C., in at least a 500-fold molar amount relative to the nickel. When copper is to be removed, it is preferable that a temperature be 1600° C. or higher. Zinc, manganese, zirconium and vanadium can be removed by using AlCl₃ (mol) at 1500-1600° C., in at least a 50-fold molar amount relative to the metal elements.

### CALCULATION EXAMPLES D-1 TO D-33

### Germanium-Metal Elemental Species-AlCl₃ System

Gallium, indium, boron, tin, aluminum, iron, nickel, chromium and manganese were employed as impurity elements, and equilibrium calculation was performed in the same manner as Calculation Example A-1 under the conditions shown in Table 7. The impurities are removed by reaction between germanium containing the impurities and the prescribed amount of AlCl₃. This is clear from the results of Calculation Examples D-1 to D-33 shown in Tables 7 and 8 below.

TABLE 7

| | | | | | AlCl₃/M′ | |
|---|---|---|---|---|---|---|
| Calculation | Ge | Impurity | M′ | AlCl₃ | molar | Temp. |
| Ex. | (mol) | element M′ | (mol) | (mol) | ratio | (° C.) |
| D-1 | 100 | Ga | 0.1 | 5 | 50 | 1500 |
| D-2 | 100 | Ga | 0.01 | 5 | 500 | 1500 |
| D-3 | 100 | Ga | 0.01 | 5 | 500 | 1600 |
| D-4 | 100 | In | 0.1 | 5 | 50 | 1500 |
| D-5 | 100 | In | 0.01 | 5 | 500 | 1500 |
| D-6 | 100 | In | 0.01 | 5 | 500 | 1600 |
| D-7 | 100 | B | 0.01 | 5 | 500 | 1500 |
| D-8 | 100 | B | 0.001 | 5 | 5000 | 1500 |
| D-9 | 100 | B | 0.01 | 5 | 500 | 1600 |
| D-10 | 100 | Sn | 0.1 | 5 | 50 | 1500 |
| D-11 | 100 | Sn | 0.01 | 5 | 500 | 1500 |
| D-12 | 100 | Sn | 0.01 | 5 | 500 | 1600 |
| D-13 | 100 | Al | 0.1 | 5 | 50 | 1000 |
| D-14 | 100 | Al | 0.1 | 5 | 50 | 1200 |
| D-15 | 100 | Al | 0.1 | 5 | 50 | 1400 |
| D-16 | 100 | Al | 0.1 | 5 | 50 | 1600 |
| D-17 | 100 | Fe | 0.1 | 5 | 50 | 1000 |
| D-18 | 100 | Fe | 0.1 | 5 | 50 | 1200 |
| D-19 | 100 | Fe | 0.1 | 5 | 50 | 1400 |
| D-20 | 100 | Fe | 0.1 | 5 | 50 | 1600 |
| D-21 | 100 | Ni | 0.1 | 5 | 50 | 1000 |
| D-22 | 100 | Ni | 0.1 | 5 | 50 | 1200 |
| D-23 | 100 | Ni | 0.1 | 5 | 50 | 1400 |
| D-24 | 100 | Ni | 0.1 | 5 | 50 | 1600 |
| D-25 | 100 | Ni | 0.01 | 5 | 500 | 1600 |
| D-26 | 100 | Cr | 0.1 | 5 | 50 | 1000 |
| D-27 | 100 | Cr | 0.1 | 5 | 50 | 1200 |
| D-28 | 100 | Cr | 0.1 | 5 | 50 | 1400 |
| D-29 | 100 | Cr | 0.1 | 5 | 50 | 1600 |
| D-30 | 100 | Mn | 0.1 | 5 | 50 | 1000 |
| D-31 | 100 | Mn | 0.1 | 5 | 50 | 1200 |
| D-32 | 100 | Mn | 0.1 | 5 | 50 | 1400 |
| D-33 | 100 | Mn | 0.1 | 5 | 50 | 1600 |

TABLE 8

| | | M′ | | | | | | | | | | | | |
|---|---|---|---|---|---|---|---|---|---|---|---|---|---|---|
| | | (solid or | | | | | | | | | | | | M′ |
| Calculation | Impurity | liquid) | M′Geₓ | Ge | GeCl₂ | GeCl | AlCl₃ | AlCl₂ | AlCl | Al₂Cl₆ | M′Cl₃ | M′Cl₂ | M′Cl | (gas) |
| Ex. | element M′ | (mol) | (mol) | (mol) | (mol) | (mol) | (mol) | (mol) | (mol) | (mol) | (mol) | (mol) | (mol) | (mol) |
| D-1 | Ga | 0 | 0 | 97.92 | 1.247 | 0.833 | 1.296 | 3.678 | 0.026 | — | — | 0.0033 | 0.0966 | — |
| D-2 | Ga | 0 | 0 | 97.75 | 1.38 | 0.869 | 1.353 | 3.623 | 0.024 | — | — | 0.0004 | 0.0964 | — |
| D-3 | Ga | 0 | 0 | 97.23 | 1.335 | 1.433 | 0.883 | 4.064 | 0.053 | — | — | 0.0003 | 0.0971 | — |
| D-4 | In | 0 | 0 | 97.92 | 1.247 | 0.833 | 1.296 | 3.678 | 0.026 | — | — | 0.0019 | 0.0981 | — |
| D-5 | In | 0 | 0 | 97.75 | 1.38 | 0.869 | 1.353 | 3.623 | 0.024 | — | — | 0.0002 | 0.0098 | — |
| D-6 | In | 0 | 0 | 97.23 | 1.335 | 1.433 | 0.883 | 4.064 | 0.053 | — | — | 0.0002 | 0.0098 | — |
| D-7 | B | 0 | 0 | 97.92 | 1.247 | 0.833 | 1.296 | 3.678 | 0.026 | — | 0.0094 | — | — | — |
| D-8 | B | 0 | 0 | 97.75 | 1.38 | 0.869 | 1.353 | 3.623 | 0.024 | — | 0.0009 | — | — | — |
| D-9 | B | 0 | 0 | 97.23 | 1.335 | 1.433 | 0.883 | 4.064 | 0.053 | — | 0.0085 | — | — | — |
| D-10 | Sn | 0 | 0 | 97.92 | 1.247 | 0.833 | 1.296 | 3.678 | 0.026 | — | — | 0.0677 | 0.0322 | — |
| D-11 | Sn | 0 | 0 | 97.75 | 1.38 | 0.869 | 1.353 | 3.623 | 0.024 | — | — | 0.0069 | 0.0031 | — |
| D-12 | Sn | 0 | 0 | 97.23 | 1.335 | 1.433 | 0.883 | 4.064 | 0.053 | — | — | 0.0057 | 0.0043 | — |
| D-13 | Al | 0 | 0 | 99.85 | 0.0958 | 0.0055 | 4.074 | 0.858 | 0.0002 | 0.0838 | — | — | — | — |
| D-14 | Al | 0 | 0 | 99.46 | 0.471 | 0.0725 | 3.164 | 1.911 | 0.0018 | 0.0115 | — | — | — | — |
| D-15 | Al | 0 | 0 | 98.62 | 0.967 | 0.409 | 1.862 | 3.223 | 0.0125 | 0.0013 | — | — | — | — |
| D-16 | Al | 0 | 0 | 97.66 | 1.065 | 1.276 | 0.838 | 4.199 | 0.0627 | 0.0001 | — | — | — | — |
| D-17 | Fe | 0.0753 | 0 | 99.85 | 0.0958 | 0.0055 | 4.074 | 0.858 | 0.0002 | 0.0838 | — | 0.0264 | — | — |
| D-18 | Fe | 0 | 0 | 99.46 | 0.471 | 0.0725 | 3.164 | 1.911 | 0.0018 | 0.0115 | — | 0.1 | — | — |
| D-19 | Fe | 0 | 0 | 98.62 | 0.967 | 0.409 | 1.862 | 3.223 | 0.0125 | 0.0013 | — | 0.1 | — | — |
| D-20 | Fe | 0 | 0 | 97.66 | 1.065 | 1.276 | 0.838 | 4.199 | 0.0627 | 0.0001 | — | 0.0999 | — | — |
| D-21 | Ni | 0 | 0.1 | 99.85 | 0.0958 | 0.0055 | 4.074 | 0.858 | 0.0002 | 0.0838 | — | — | — | — |
| D-22 | Ni | 0 | 0.0996 | 99.46 | 0.471 | 0.0725 | 3.164 | 1.911 | 0.0018 | 0.0115 | — | 0.0004 | — | — |
| D-23 | Ni | 0 | 0.097 | 98.62 | 0.967 | 0.409 | 1.862 | 3.223 | 0.0125 | 0.0013 | — | 0.0026 | 0.0004 | — |
| D-24 | Ni | 0 | 0.089 | 97.66 | 1.065 | 1.276 | 0.838 | 4.199 | 0.0627 | 0.0001 | — | 0.0074 | 0.0033 | 0.0003 |
| D-25 | Ni | 0 | 0 | 97.25 | 0.899 | 1.427 | 0.899 | 4.047 | 0.0543 | 0.0001 | — | 0.007 | 0.0028 | 0.0002 |
| D-26 | Cr | 0.0456 | 0 | 99.85 | 0.0958 | 0.0055 | 4.074 | 0.858 | 0.0002 | 0.0838 | — | 0.0543 | — | — |
| D-27 | Cr | 0 | 0 | 99.46 | 0.471 | 0.0725 | 3.164 | 1.911 | 0.0018 | 0.0115 | 0.0001 | 0.0999 | — | — |
| D-28 | Cr | 0 | 0 | 98.62 | 0.967 | 0.409 | 1.862 | 3.223 | 0.0125 | 0.0013 | — | 0.1 | — | — |
| D-29 | Cr | 0 | 0 | 97.66 | 1.065 | 1.276 | 0.838 | 4.199 | 0.0627 | 0.0001 | — | 0.0999 | — | — |
| D-30 | Mn | 0 | 0 | 99.85 | 0.0958 | 0.0055 | 4.074 | 0.858 | 0.0002 | 0.0838 | — | 0.1 | — | — |
| D-31 | Mn | 0 | 0 | 99.46 | 0.471 | 0.0725 | 3.164 | 1.911 | 0.0018 | 0.0115 | — | 0.1 | — | — |
| D-32 | Mn | 0 | 0 | 98.62 | 0.967 | 0.409 | 1.862 | 3.223 | 0.0125 | 0.0013 | — | 0.1 | — | — |
| D-33 | Mn | 0 | 0 | 97.66 | 1.065 | 1.276 | 0.838 | 4.199 | 0.0627 | 0.0001 | — | 0.0998 | — | 0.0002 |

When iron and chromium are to be removed, AlCl₃ (mol) may be blown in at 1200° C. or higher, in at least a 50-fold molar amount relative to the iron or chromium. When nickel is to be removed, NiGeₓ alloy tends to be formed at 1000° C. or greater and not greater than 1600° C., and therefore it is preferable that AlCl₃ (mol) be blown in at 1600° C. or higher, in at least a 500-fold molar amount relative to the nickel.

(Contact Method for Purification)

The method of bringing the AlX₃ into contact with the material containing a metalloid element or metal element as the main component and impurities will now be explained in detail with reference to the accompanying drawings.

There are no particular restrictions on the state of the AlX₃ and the material containing a metalloid element main component and impurities, when they are contacted.

For example, the material containing a metalloid element or metal element as the main component and impurities may be in solid (for example, powder), liquid or gas form, but from the viewpoint of efficient contact between the impurities and AlX₃, it is preferable that it be in liquid or gas form, and because a considerably high temperature is necessary to form a gas, it is most preferable that it be in liquid form. When the material containing a metalloid element or metal element as the main component and impurities is in solid form, it is preferable that it be a powder from the viewpoint of efficient contact with the AlX₃.

For example, when the main component of the material is silicon, the melting point of silicon is approximately 1410° C., and a material temperature of 1420° C. or higher brings the material to a generally liquid or molten state. By lowering the material to below 2000° C., generation of silicon gas can be inhibited, and this is therefore preferred.

From the same viewpoint, when the main component of the material is germanium, the melting point of germanium is approximately 940° C., and the temperature of the material may be 950° C. or higher. When the main component of the material is copper, the melting point of copper is approximately 1080° C., and the temperature of the material may be 1090° C. or higher. When the main component of the material is nickel, the melting point of nickel is approximately 1450° C., and the temperature of the material may be 1460° C. or higher.

The AlX₃ may also be in the form of a solid (for example, powder), liquid or gas, but from the viewpoint of efficient contact between the impurities and AlX₃, it is preferable that it be in the form of a liquid or gas, and especially because AlX₃ usually has a sublimating property that makes it difficult to form a liquid, it is preferable that it be in the form of a gas.

Specifically, when the AlX₃ is a compound with a sublimating property such as AlF₃ or AlCl₃, for example, it is preferable that the AlX₃ be heated above its sublimation point to form a gas. Even if the AlX₃ is a compound without a sublimating property, from the viewpoint of reactivity with the impurities in the material, it is preferable that the AlX₃ be heated to near the boiling point to form a gas.

It is particularly preferable that the material be liquefied and brought into contact with the AlX₃ as a gas.

There are no particular restrictions on the method of contacting the AlX₃ with the material containing a metalloid element or metal element as the main component and impurities. For example, if one is a liquid and the other a gas, it is preferable that the gas be blown into the liquid. For example, when AlCl₃ is used, it is preferable that anhydrous AlCl₃ be heated to near the sublimation point and conveyed with an inert gas such as Ar, to be blown into the molten material. Controlling the heating temperature of the compound such as AlCl₃ during this time allows control of the concentration of the AlX₃ gas.

When AlX₃ is to be introduced as a gas, the gas used for conveying may be an inert gas such as He, Ar or N₂ and/or a reducing gas such as H₂. These may be used alone, or two or more may be used in admixture. Reaction with N₂ or H₂ may occur depending on the substance to be purified, and in such cases an inert gas such as He or Ar is preferred. The purity of the gas is 99% by mass or greater, it is preferable that it be 99.9% by mass or greater and, it is even more preferable that it be 99.99% by mass or greater.

For example, when AlCl₃ is mixed with an inert gas for introduction, it is preferable that the concentration of AlCl₃ in the gaseous mixture of the AlCl₃ and inert gas be 10% by volume or greater and not greater than 40% by volume. If the concentration is less than 10% by volume almost no reaction will proceed between the impurity and AlCl₃ in the material, and this is therefore undesirable. If the concentration exceeds 40% by volume, a portion of the AlCl₃ will tend to be discharged out of the reaction system without participating in the reaction and the reaction will not take place efficiently, and this is therefore undesirable.

Solid or liquid AlX₃ may also be loaded directly into the molten material. In this case, the solid AlX₃ becomes gasified in the molten material, so that a stirring effect in the molten liquid can be expected, but an excessively large loading amount may run the risk of bumping or the like, and therefore care must be taken for gradual loading.

Even when the material containing a metalloid element as the main component and impurities is a solid, it is possible to carry out the invention by reacting it as a fine powder, for example, with the AlX₃. It is preferable that the particle size of the powder be 100 μm or greater and not greater than 5 mm, and it is more preferable that it be 0 5 mm or greater and not greater than 1 mm. If the particle size is less than 100 μm handling will become difficult, and this is therefore undesirable. If the particle size exceeds 5 mm, the specific surface area will decrease, the contact area between the compound AlX₃ represented by formula (1) above and the material will decrease, and the reaction will proceed with difficulty, and this is therefore undesirable.

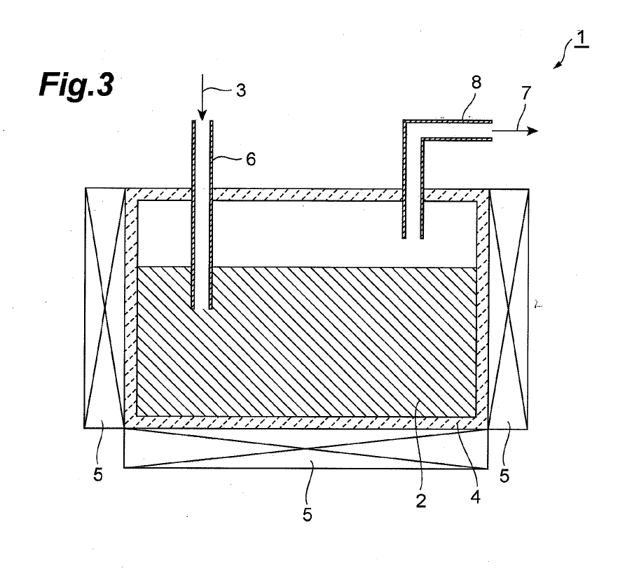

FIG. 3 shows an example of a purification apparatus for carrying out a method for purifying a material according to the invention. The purification apparatus 1 comprises a container 4 equipped with a heating apparatus 5, and a pipe 6 through which the compound 3 represented by formula (1) above is introduced into the container 4. In the method for purifying a material containing a metalloid element or metal element as the main component, according to this embodiment, the material 2 containing a metalloid element M or metal element M as the main component and an impurity M′, as the target of purification, is placed in the container 4 and kept in a molten state, and the AlX₃ gas is introduced into the container 4 through a pipe 6 and brought into contact with the material 2.

In the purification apparatus 1, the reactor 4 used is one that is inert to the molten material containing a metalloid element such as silicon or germanium or a metal element such as copper or nickel as the main component, and that has heat resistance. Specifically, carbon materials such as graphite, and materials composed mainly of silicon carbide, silicon nitride, aluminum nitride, alumina (aluminum oxide) or quartz are preferred for use.

The pipe 6 for introduction of the AlX₃ (where X represents a halogen atom) will usually be, similar to the reactor 4, one that is inert to the material containing a metalloid element such as silicon or germanium or a metal element such as copper or nickel as the main component, and that has heat resistance. Specifically, carbon materials such as graphite, and materials composed mainly of silicon carbide, silicon nitride, aluminum nitride, alumina (aluminum oxide), quartz and the like are preferred for use.

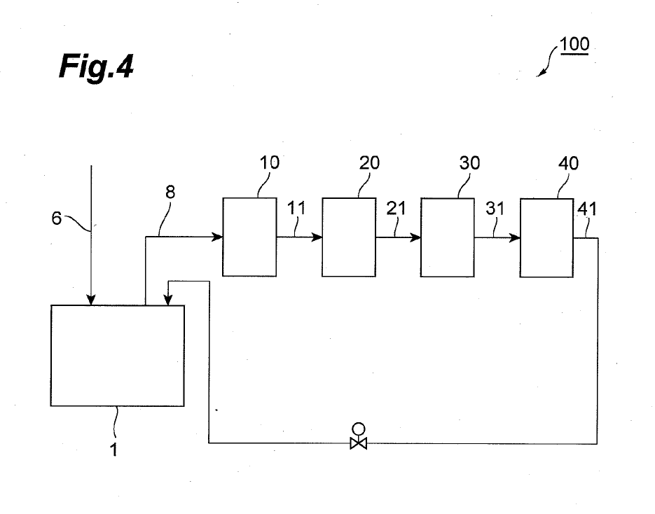

FIG. 4 is an example of applying the purification apparatus described above. The purification system 100 is constructed with the purification apparatus 1, a disproportionation apparatus 10, an M′X_{q}-removing apparatus 20, an MXₚ-removing apparatus 30 and an AlX₃ purification apparatus 40, connected together.

The purification system 100 recovers and purifies AlX₃ at high efficiency from the mixed gas comprising AlX₂, AlX, MXₚ, M′X_{q} and unreacted AlX₃, which is discharged from the purification apparatus 1 through a line 8, finally returning and circulating it to the purification apparatus 1.

In the purification apparatus 1, the AlX₃ introduced through the line 6 is brought into contact with the material containing M as the main component and an impurity M′, and the gas including the produced AlX₂, AlX, MXₚ and M′X_{q} and the unreacted AlX₃ is discharged to the disproportionation apparatus 10 through the line 8.

The disproportionation apparatus 10 decomposes the AlX₂ and AlX aluminum subhalides to Al and AlX₃ at the prescribed temperature. The aluminum subhalides produced by the reaction are thermodynamically unstable, and are decomposed to Al and AlX₃ by disproportionation reaction in a temperature range of up to approximately 1000° C. Thus, directing the aluminum subhalides to a container kept at a temperature at which disproportionation reaction takes place allows separation and removal of the solid Al and gaseous AlX₃. The exhaust gases supplied from the disproportionation apparatus 10 to the M′X_{q}-removing apparatus 20 through the line 11 are MXₚ, M′X_{q} and AlX₃. When M′X_{q} is solid, the downstream M′X_{q} removing apparatus 20 may be omitted.

When M′X_{q} is a gas, the M′X_{q}-removing apparatus 20 decomposes the M′X_{q} into, for example, solid M′ and solid or liquid M′Xᵣ (where r is an integer of 0 or greater and different from q), at the prescribed temperature. This allows separation and removal of the gaseous M′X_{q} from the gaseous mixture of M′X_{q}, MXₚ and AlX₃. The temperature in the reactor is set to a temperature range allowing decomposition of the gaseous M′X_{q} into solid M′ and solid or liquid M′Xᵣ. Thereby, the exhaust gas 21 supplied from the M′X_{q}-removing apparatus 20 to the MXₚ-removing apparatus 30 through a line 21, becomes to be composed of MXₚ and AlX₃.

When MXₚ is a gas, the MXₚ-removing apparatus 30, similar to the M′X_{q}-removing apparatus 20 described above, decomposes the MXₚ into, for example, solid M and solid or liquid MXₛ (where s is an integer of 0 or greater different from p), at the prescribed temperature. This allows separation and removal of the gaseous MXₚ from the gaseous mixture 21 of MXₚ and AlX₃. The temperature in the reactor is set to a temperature range allowing decomposition of the gaseous MXₚ into solid M and solid or liquid MXₛ. Thereby, the exhaust gas supplied from the MXₚ-removing apparatus 30 to the AlX₃ purification apparatus 40 through a line 31, becomes to be composed of gaseous AlX₃ alone.

The AlX₃ purification apparatus 40 purifies the gaseous AlX₃ at a prescribed temperature. This allows the purified gaseous AlX₃ to be returned to the purification apparatus 1 through the line 41, for reuse in purification of the material containing the metalloid element or metal element as the main component and impurities.

By employing the method for purifying a material containing a metalloid element or metal element as the main component, according to the invention, it is possible to remove impurities in a material containing a metalloid element or metal element as the main component using a reactor having a relatively simple construction, and to efficiently obtain the purified material containing a metalloid element or metal element as the main component.

### EXAMPLES

The present invention will now be further explained by examples, with the understanding that the invention is not limited to the examples.

### Example 1

A high-purity silicon [purity: 99.99999%+] of 86.7 g and a high-purity aluminum [purity: 99.999%+, product of Sumitomo Chemical Co., Ltd.] of 0.88 g were charged into a graphite crucible [inner diameter: 4 cm, depth: 18 cm, internal volume: approximately 0.2 L]. The crucible was heated to 1540° C. in an electric furnace to melt the high-purity silicon and high-purity aluminum, to yield a mixed molten liquid of silicon and aluminum. The molten liquid had a depth of approximately 30 mm in the crucible. The aluminum concentration in the molten liquid was 1.00% by mass, calculated from the charged amount.

A vaporizer filled with 44.2 g of aluminum chloride [purity: 98%, anhydrous, product of Wako Junyaku Co., Ltd.] was heated to 200° C. to generate aluminum chloride gas, and the aluminum chloride gas was used as a carrier gas and blown in together with argon gas at 0.1 L/min through a blowing tube, into the molten liquid in the crucible, for a period of 120 minutes. The blowing tube used was an alumina tube with an outer diameter of 0.6 cm, an inner diameter of 0.4 cm and a length of 70 cm, and the end of the blowing tube was inserted from the surface of the molten liquid up to a depth of about 22 mm for blowing of the gas. Upon completion of the blowing, the blowing tube was drawn up from the molten liquid and heating of the vaporizer was also interrupted. The weight of the aluminum chloride remaining in the vaporizer was measured after completion of the blowing and found to be 16.4 g, and the difference of 27.8 g from the initial loading weight of 44.2 g was the weight of aluminum chloride blown into the molten liquid. The concentration of aluminum chloride gas in the blown gas (aluminum chloride gas+argon gas) was calculated to be 28.0% by volume.

Next, a positive temperature gradient of 0.9° C./mm was created from the bottom of the molten liquid toward the liquid surface, after which directional solidification was carried out from the bottom to the liquid surface at a rate of solidification of 0.2 mm/min, to yield a solid metal.

The aluminum content in the obtained solid metal was quantified by inductively coupled plasma (ICP) luminescence analysis, and the aluminum concentration of the solid metal was found to be 0.17% by mass.

### Example 2

A solid metal was yielded in the same manner as Example 1, except that the amount of high-purity aluminum charged into the crucible was 0.44 g.

The aluminum concentration in the molten liquid before blowing in the aluminum chloride gas was 0.50% by mass, based on calculation from the charged amount. The weight of the aluminum chloride remaining in the vaporizer was measured after completion of the blowing and found to be 32.1 g, and the difference of 11.2 g from the initial loading weight of 43.3 g was the weight of aluminum chloride blow into the molten liquid. The concentration of aluminum chloride gas in the blown gas (aluminum chloride gas+argon gas) was calculated to be 13.5% by volume.

The aluminum content in the obtained solid metal was quantified by inductively coupled plasma (ICP) luminescence analysis, and the aluminum concentration of the solid metal was found to be 0.09% by mass.

### Comparative Example 1

This example was conducted in the same manner as Example 1, except that argon gas containing no aluminum chloride gas was blown into the molten liquid.

The aluminum concentration of the molten liquid before blowing in the argon gas was 1.00% by mass as in Example 1.

The aluminum content in the yielded solid metal was quantified by inductively coupled plasma (ICP) luminescence analysis, and the aluminum concentration of the solid metal was found to be 0.53% by mass.

### Comparative Example 2

A solid metal was yielded in the same manner as Comparative Example 1, except that the amount of high-purity aluminum charged into the crucible was 0.44 g.

The aluminum concentration of the molten liquid before blowing in the argon gas was 0.50% by mass as in Example 2.

The aluminum content in the yielded solid metal was quantified by inductively coupled plasma (ICP) luminescence analysis, and the aluminum concentration of the solid metal was found to be 0.65% by mass.

### Example 3

This example was conducted in the same manner as Example 1, except that 87.2 g of metallurgical grade silicon [purity: 99.58%, product of Shinko-Frex, Inc.] was charged into the crucible instead of high-purity silicon and high-purity aluminum. Metallurgical grade silicon contains, as major impurities, an Al concentration of 610 ppmwt (parts per million weight), an Fe concentration of 3400 ppmwt, a B concentration of 36 ppmwt, a P concentration of 35 ppmwt, a Ca concentration of 28 ppmwt, a Ti concentration of 230 ppmwt and an Mn concentration of 330 ppmwt.

The weight of the aluminum chloride remaining in the vaporizer, measured after completion of blowing of the aluminum chloride gas, was found to be 3.9 g, and the difference of 17.6 g from the initial loading weight of 21.5 g was the weight of aluminum chloride blown into the molten liquid. The concentration of aluminum chloride gas in the blown gas (aluminum chloride gas+argon gas) was calculated to be 19.8% by volume.

When the impurity content of the obtained solid metal was quantified by inductively coupled plasma (ICP) luminescence analysis, the Ca concentration in the solid metal was found to be reduced to 7 ppmwt.

### Example 4

This example was conducted in the same manner as Example 3, except that the amount of metallurgical grade silicon charged into the crucible was 98.2 g. The weight of the aluminum chloride remaining in the vaporizer, measured after completion of blowing of the aluminum chloride gas, was found to be 2.6 g, and the difference of 31.1 g from the initial loading weight of 33.7 g was the weight of aluminum chloride blown into the molten liquid. The concentration of aluminum chloride gas in the blown gas (aluminum chloride gas+argon gas) was calculated to be 30.4% by volume. When the impurity content of the yielded solid metal was quantified by inductively coupled plasma (ICP) luminescence analysis, the solid metal was found to have an Al concentration of 570 ppmwt, an Fe concentration of 2700 ppmwt, a B concentration of 22 ppmwt, a P concentration of 37 ppmwt, a Ca concentration of 1 ppmwt, a Ti concentration of 180 ppmwt and an Mn concentration of 260 ppmwt. Increasing the aluminum chloride gas concentration above that in Example 3 resulted in reduction not only in the Ca concentration but also the Al concentration, Fe concentration, B concentration, Ti concentration and Mn concentration.

### Example 5

Solid silicon containing 5% by mass aluminum was crushed and sifted, to prepare aluminum-containing solid silicon with particle sizes of 0.5 mm or greater and not greater than 1 mm. The yielded aluminum-containing solid silicon of 0.71 g was charged into a graphite crucible [inner diameter: 4 cm, depth: 18 cm, internal volume: approximately 0.2 L]. The crucible was heated to 1390° C. in an electric furnace, and the charged silicon was heated and kept in a solid state.

A vaporizer filled with 31.9 g of aluminum chloride [purity: 98%, anhydrous, product of Wako Junyaku Co., Ltd.] was heated to 200° C. to generate aluminum chloride gas, and the aluminum chloride gas was used as a carrier gas and blown in together with argon gas at 0.1 L/min through a blowing tube, into the solid silicon in the crucible, for a period of 120 minutes. The blowing tube used was an alumina tube with an outer diameter of 0.6 cm, an inner diameter of 0.4 cm and a length of 70 cm, and the blowing tube was inserted from the surface of the solid silicon up to 10 mm below it for blowing of the gas. Upon completion of the blowing, the blowing tube was drawn up from the molten liquid and heating of the vaporizer was also interrupted. The weight of the aluminum chloride remaining in the vaporizer was measured after completion of the blowing and found to be 1.9 g, and the difference of 30.0 g from the initial loading weight of 31.9 g was the weight of aluminum chloride blown into the molten liquid. The concentration of aluminum chloride gas in the blown gas (aluminum chloride gas+argon gas) was calculated to be 29.5% by volume.

The silicon after blowing was cooled to yield a solid metal.

The aluminum content in the yielded solid metal was quantified by inductively coupled plasma (ICP) luminescence analysis, and the aluminum concentration of the solid metal was found to be 1.7% by mass.

### Comparative Example 3

This example was conducted in the same manner as Example 5, except that the amount of aluminum-containing solid silicon charged into the crucible was 1.40 g, and argon gas containing no aluminum chloride gas was blown into the molten liquid. The aluminum content in the yielded solid metal was quantified by inductively coupled plasma (ICP) luminescence analysis, and the aluminum concentration of the solid metal was found to be 1.9% by mass.

### EXPLANATION OF SYMBOLS

1: Purification apparatus, 2: material containing metalloid element as main component and impurities, 3: compound represented by AlX₃, 4: container, 5: heating apparatus, 6: introduction pipe (line), 7: product gas, 11,21,31,41: lines, 8: product gas discharge pipe (line), 10: disproportionation apparatus, 20: M′X_{q}-removing apparatus, 30: MXₚ-removing apparatus, 40: AlX₃ purification apparatus, 100: purification system.

1. A method for purifying a material, comprising bringing a material containing a metalloid element or metal element as the main component, and an impurity into contact with a compound represented by the following formula (1):
AlX₃ (1)
wherein X is a halogen atom; to remove the impurity from the material.

2. The method for purifying a material according to claim 1, wherein the material contains silicon, germanium, copper or nickel as the main component.

3. The method for purifying a material according to claim 1, wherein the material contains silicon as the main component.

4. The method for purifying a material according to claim 1, wherein the material contains silicon as the main component, and the impurity is one or more elements selected from the group consisting of lithium, sodium, potassium, rubidium, cesium, beryllium, magnesium, calcium, strontium, barium, zirconium, aluminum, titanium, gallium, indium, vanadium, manganese, chromium, tin, lead, germanium, iron, boron, zinc, copper, nickel and rare earth metals, or an alloy comprising one or more of these elements.

5. The method for purifying a material according to claim 1, wherein the material contains germanium as the main component, and the impurity is one or more elements selected from the group consisting of lithium, sodium, potassium, rubidium, cesium, beryllium, magnesium, calcium, strontium, barium, zirconium, aluminum, titanium, gallium, indium, vanadium, manganese, chromium, tin, lead, silicon, iron, boron, cobalt, zinc, copper, nickel and rare earth metals, or an alloy comprising one or more of these elements.

6. The method for purifying a material according to claim 1, wherein the material contains copper as the main component, and the impurity is one or more elements selected from the group consisting of lithium, sodium, potassium, rubidium, cesium, beryllium, magnesium, calcium, strontium, barium, zirconium, aluminum, titanium, gallium, indium, vanadium, manganese, chromium, tin, lead, silicon, germanium, iron, cobalt, boron, zinc, nickel and rare earth metals, or an alloy comprising one or more of these elements.

7. The method for purifying a material according to claim 1, wherein the material contains nickel as the main component, and the impurity is one or more elements selected from the group consisting of lithium, sodium, potassium, rubidium, cesium, beryllium, magnesium, calcium, strontium, barium, zirconium, aluminum, titanium, gallium, indium, vanadium, manganese, chromium, tin, lead, silicon, germanium, iron, cobalt, copper, boron, zinc and rare earth metals, or an alloy comprising one or more of these elements.

8. The method for purifying a material according to claim 1, wherein the material is in a molten state.

9. The method for purifying a material according to claim 1, wherein the material is a powder.

10. The method for purifying a material according to claim 3, wherein the material contains silicon of at least 97% by mass.

11. The method for purifying a material according to claim 3, wherein the temperature of the material is 600° C. or higher and less than 2000° C.

12. The method for purifying a material according to claim 3, wherein the temperature of the material is 1420° C. or higher and less than 2000° C.

13. The method for purifying a material according to claim 1, wherein the compound represented by formula (1) is a gas.

14. The method for purifying a material according to claim 13, wherein the compound represented by formula (1) is present in a gaseous mixture with an inert gas.

15. The method for purifying a material according to claim 1, wherein the compound represented by formula (1) is AlCl₃.

16. The method for purifying a material according to claim 14, wherein the compound represented by formula (1) is AlCl₃, and the concentration of the AlCl₃ in the gaseous mixture is 10% by volume or greater and not greater than 40% by volume.

17. The method for purifying a material according to claim 14, wherein the inert gas is an element selected from the group consisting of argon, nitrogen and helium, or a mixed gas comprising two or more thereof.
